(19) United States
(12) Patent Application Publication
(10) Pub. No.: US 2017/0283141 A1
(43) Pub. Date: Oct. 5, 2017

(54) WINDING RESISTANT CARDBOARD

(71) Applicant: UGPAPER CO., LTD., Kaohsiung City (TW)

(72) Inventor: SHENG-TSUNG LEE, KAOHSIUNG CITY (TW)

(21) Appl. No.: 15/227,095

(22) Filed: Aug. 3, 2016

(30) Foreign Application Priority Data
Mar. 29, 2016 (TW) 105204340

(51) Int. Cl. B65D 65/38; B32B 3/28; B32B 29/08; B32B 3/12

(52) U.S. Cl. CPC B65D 65/38; B32B 3/12; B32B 3/28; B32B 29/08; B32B 2553/00; B32B 2307/544

(57) ABSTRACT

This invention is related to a winding resistant cardboard, which mainly has at least one support unit and at least one carrying unit. The support unit has a cross section in a rectangular shape lacking one side to form an opening laterally disposed to face the at least one carrying unit. The carrying unit is formed by a plurality of corrugated boards disposed vertically and bound abreast. The support unit is formed by a plurality of stacked cardboards bound and pressed together to provide winding resistant function like beams and columns. The good pressure bearing strength of the support unit formed by a plurality of corrugated boards disposed vertically and attached abreast also help the winding resistant cardboard not to be bent and deformed under a heavy weight. Accordingly, the safety of the winding resistant cardboard as a building material or a packaging material can be elevated.

### BACKGROUND

### Field of Invention

The disclosure relates to a winding resistant cardboard. More particularly, the disclosure relates to a winding resistant cardboard having a good winding resistant strength and a compressive strength to carry heavy weight and won't be bent.

### Description of Related Art

The present building boards and packaging materials are mainly made from woods, plastics, and metals. Among them, the wood building materials or packaging materials are obtained by deforestation, which cause the problem of destroying environment. Moreover, after a period of time, woods are prone to rot. The plastic building or packaging materials are formed by injection molding, which needs a mold to be produced, and thus the cost is high. Furthermore, the waster of the plastic materials cannot be naturally discomposed, and environmental pollution is thus caused. The weight of the metal building or packaging materials is heavy, and thus the production and transportation cost is high. Moreover, the sharp edges of the metal building or packaging materials can easily harm the porters or goods during transportation.

Therefore, in view of the drawbacks of environmental protection and cost of building or packaging materials made from wood, plastic, and metal, some people research and develop paper building or packaging materials. The paper building or packaging materials may be made from recycled cardboards to reduce the material cost. The paper materials also can be recycled to decrease the waste materials. This feature meets the market requirement, and the light weight of the paper materials make the paper materials can be easily transport. However, the present paper building or packaging materials have drawbacks of insufficient winding resistance, poor loading weight, and easy deformation to seriously affect the safety of the use. Therefore, how to improve the supporting force and winding resistance is the most focus issue in the industry.

Therefore, in view of drawbacks of environmental protection and cost of wood, plastic, and metal building materials and packaging materials, the inventors develop this invention by the many-year manufacturing and design experience and knowledge in the related fields and ingenuity to improve the present cardboard structure for the building or the packaging materials.

### SUMMARY

This invention relates to a winding resistant cardboard having a good winding resistant strength and a compressive strength to carry heavy weight but won't be bent.

In order to achieve the above aspects, a winding resistant cardboard is provided. The winding resistant cardboard comprises:

at least one support unit having a cross section in a rectangular shape lacking one side to form an opening, and formed by a plurality of stacked cardboards bound and pressed together; and

at least one carrying unit formed by a plurality of corrugated boards disposed vertically and bound abreast, wherein the at least one carrying unit and the at least one support unit are alternatively disposed, and the opening of the at least one support unit is laterally disposed to face the at least one carrying units.

In the winding resistant cardboard above, the winding resistant cardboard further comprises a wrapping unit comprises an upper cardboard and a lower cardboard attached on a top surface and a bottom surface of the at least one support unit and the at least one carrying unit bound together.

In the winding resistant cardboard above, the wrapping unit further comprises two side cardboards respectively attached to the two outermost side surfaces of the bound support unit and carrying unit to stick onto the two outermost side surfaces of the outermost support unit or the carrying unit.

The support unit is formed by a plurality of stacked cardboards bound and pressed together to provide winding resistant function like beams and columns. The good pressure bearing strength of the support unit formed by a plurality of corrugated boards disposed vertically and attached abreast also help the winding resistant cardboard to not be bent and deformed under a heavy weight. Accordingly, the safety of the winding resistant cardboard as a building material or a packaging material can be elevated. In addition, the upper cardboard, the lower cardboard, and the two side cardboards are attached to the top surface, the bottom surface, the right side surface and the left side surface of the winding resistant cardboard to increase the aesthetic appearance.

### BRIEF DESCRIPTION OF THE DRAWINGS

FIG. 1 is a diagram showing an exploded perspective view of this invention.

FIG. 2 is a diagram showing a perspective view of this invention.

FIG. 3 is a diagram showing a perspective view of another embodiment of this invention.

### DETAILED DESCRIPTION

To more completely and clearly illustrate the technical means and effects of this invention, the detailed descriptions are set forth below. Please refer to the disclosed figures and the reference numbers.

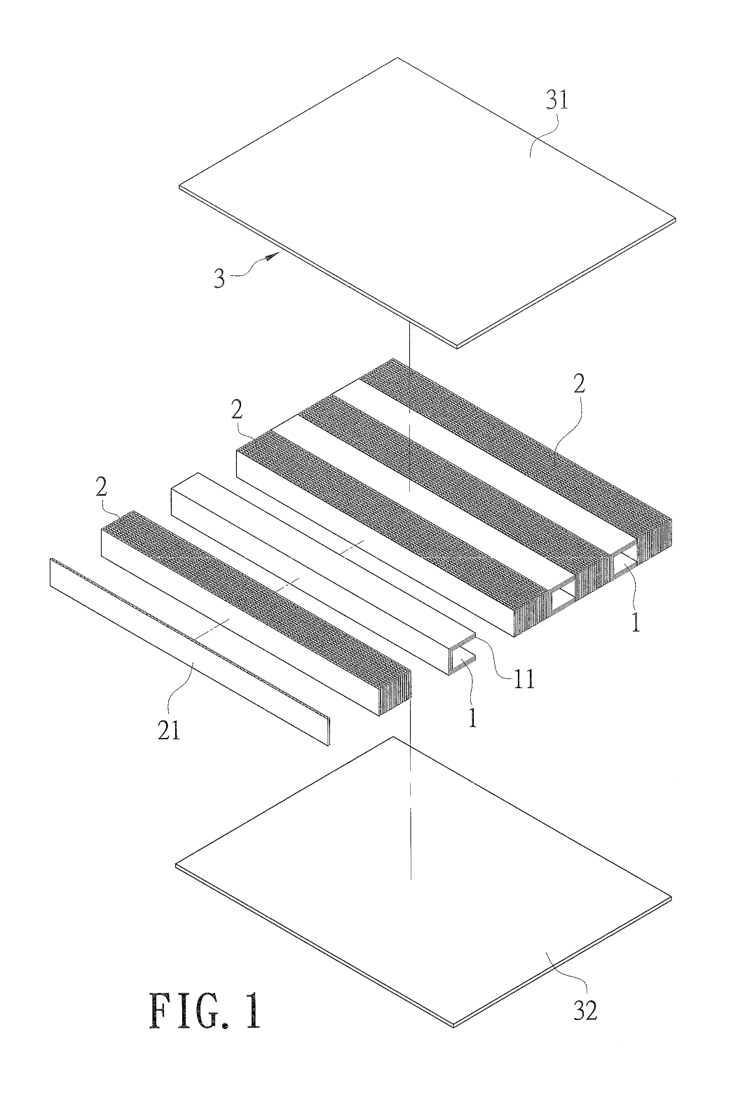

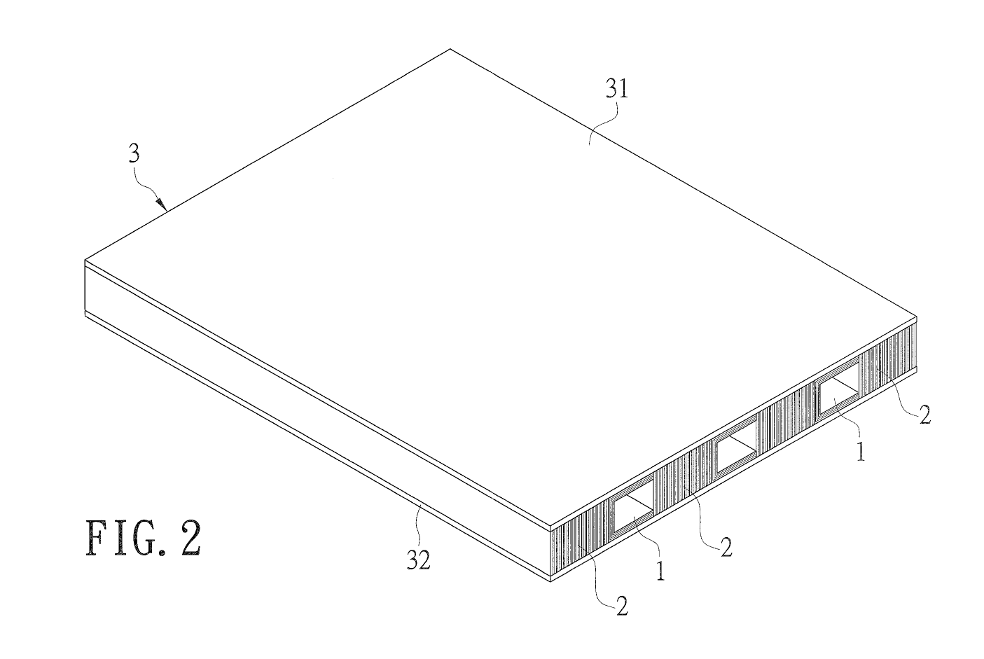

First, please refer to FIGS. 1 and 2, which are the winding resistant cardboard of this invention. The winding resistant cardboard mainly comprises at least a support unit 1, at least a carrying unit 2, and a wrapping unit 3. The support units 1 each has a cross section in a rectangular shape lacking one side to form an opening 11, and is formed by a plurality of stacked cardboards, which are bound and pressed together.

The carrying units 2 each is formed by a plurality of corrugated boards 21 disposed vertically and bound abreast. The carrying units 2 and the support units 1 are alternatively disposed, and the openings 11 of the support units 1 are laterally disposed to face the carrying units 2, as shown in FIGS. 1 and 2.

The wrapping unit 3 comprises an upper cardboard 31 and a lower cardboard 32. The upper cardboard 31 and the lower cardboard 32 are made of thick cardboards. The upper cardboard 31 and the lower cardboard 32 are respectively disposed and attached on and below the support units 1 and the carrying units 2.

When the units above are assembled, the supporting units 1 and the carrying units 2 are alternatively arranged and bound to a needed volume, and the openings 11 of the supporting units 1 are laterally disposed to face the carrying units. The upper cardboard 31 and the lower cardboard 32 with corresponding sizes are taken to lay on and then attached to the top surface and the bottom surface of the supporting units 1 and the carrying units 2 bound together to form the winding resistant cardboard of this invention.

Accordingly, when the winding resistant cardboard of this invention is used to be a packaging material, the goods can be stably placed on the planar upper cardboard 31. When a fork lift truck is used to handle the goods and warehousing, the fork of the fork lift truck can insert into the support units 1. Since the support units 1 are formed by binding and pressing a plurality of stacked thick cardboard, the support units 1 have a very high load capacity to bear the support force of the fork of the fork lift truck. Since the carrying units 2 are formed by a plurality of corrugated boards 21 disposed vertically and attached abreast, the loading weight can be effectively increased as carrying goods, and thus no bending deformation occurs. In addition, the winding resistant cardboard of this invention is used as a building material, the support units 1 can also play as support beams and columns to have winding resistant function. The good pressure bearing strength of the carrying unit 2 formed by a plurality of corrugated boards 21 disposed vertically and attached abreast also help the winding resistant cardboard to not be bent and deformed under a heavy weight. Accordingly, the safety of the winding resistant cardboard as a building material or a packaging material can be elevated.

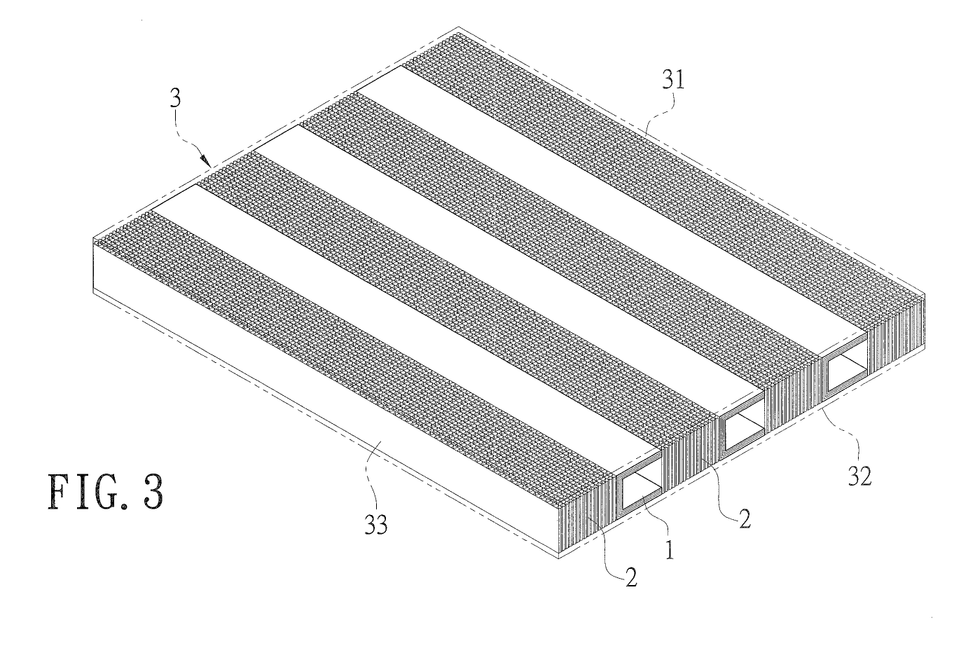

Please also refer to FIG. 3, which shows a winding resistant cardboard according to another embodiment of this invention. In FIG. 3, the winding resistant cardboard further comprises two side cardboards 33 respectively attaching to the outermost two sides of the bound support unit 1 and carrying unit 2 to stick onto the two outermost side surfaces of the outermost support unit 1 or the carrying unit 2. Therefore, the top, bottom, left and right surfaces of the winding resistant cardboard are wrapped by the upper cardboard 31, the lower cardboard 32, and the two side cardboards 33 to increase the aesthetic appearance of the winding resistant cardboard.

In light of the foregoing, this invention has the following advantages:

1. In this invention, the winding resistant cardboard utilizes a structure design comprising the supporting unit having a cross section in a rectangular shape lacking one side to form an opening and the carrying unit formed by a plurality of corrugated boards disposed vertically and bound abreast to effectively increase the winding-resistant and weight-loading strength of the paper building or packaging materials. Therefore, the suddenly deformation condition of the winding resistant cardboard can be avoided while transporting to increase the safety of use.

2. In this invention, the upper cardboard, the lower cardboard, and the two side cardboards are attached to the top surface, the bottom surface, the right side surface and the left side surface of the winding resistant cardboard to increase the aesthetic appearance.

What is claimed is:

1. A winding resistant cardboard, comprising:
at least one support unit having a cross section in a rectangular shape lacking one side to form an opening, and formed by a plurality of stacked cardboards bound and pressed together; and
at least one carrying unit formed by a plurality of corrugated boards disposed vertically and bound abreast, wherein the at least one carrying unit and the at least one support unit are alternatively disposed, and the opening of the at least one support unit is laterally disposed to face the at least one carrying units.

2. The winding resistant cardboard of claim 1, further comprising a wrapping unit comprises an upper cardboard and a lower cardboard respectively attached on a top surface and a bottom surface of the at least one support unit and the at least one carrying unit bound together.

3. The winding resistant cardboard of claim 2, wherein the wrapping unit further comprises two side cardboards respectively attached to the two outermost side surfaces of the bound support unit and carrying unit to stick onto the two outermost side surfaces of the outermost support unit or the carrying unit.
